(19) United States
(12) Patent Application Publication
(10) Pub. No.: US 2022/0348019 A1
(43) Pub. Date: Nov. 3, 2022

(54) PRINT HEAD MAINTENANCE ASSEMBLY

(71) Applicant: Hewlett-Packard Development Company, L.P., Spring, TX (US)

(72) Inventors: Santiago Forcada Pardo, Sant Cugat del Valles (ES); Jeffrey Thielman, Sant Cugat del Valles (ES); Jorge Millàn Lafuente, Sant Cugat del Valles (ES)

(73) Assignee: Hewlett-Packard Development Company, L.P., Spring, TX (US)

(21) Appl. No.: 17/262,038

(22) PCT Filed: Nov. 28, 2018
(86) PCT No.: PCT/US2018/062778

§ 371 Date: Jan. 21, 2021

(51) Int. Cl. B41J 2/165

(52) U.S. Cl. CPC B41J 2/16538; B41J 2/16541; B41J 2/16544

(57) ABSTRACT

Disclosed herein is a print head maintenance assembly, a printing device and a method of cleaning a print head. The print head maintenance assembly comprises a maintenance cartridge comprising a wiping subsystem with a wiper for wiping a print head; a scraper assembly with a scraper for cleaning the wiper; and a positioner to adjust a relative position between the scraper and the wiper in a first direction depending on a relative position between the maintenance cartridge and the scraper assembly in a second direction.

### BACKGROUND

Printing devices like ink-jet printers may have to be cleaned regularly in order to prevent a deterioration of image quality e.g. due to partial or complete clogging of print head nozzles. To this end, printing devices can comprise a maintenance subsystem, which performs cleaning operations on a print head of the printing device.

### BRIEF DESCRIPTION OF DRAWINGS

In the following, a detailed description of various examples is given with reference to the figures. The figures show schematic illustrations of

FIG. 1a: a print head maintenance assembly in accordance with an example;

FIG. 1b: an adjustment of the relative position between a scraper and a wiper of the print head maintenance assembly of FIG. 1a in accordance with an example;

FIG. 2a: a print head maintenance assembly with a support structure in accordance with an example;

FIG. 2b: an adjustment of the relative position between a scraper and a wiper of the print head maintenance assembly of FIG. 2a in accordance with an example;

FIG. 3: a printing device according to an example;

FIG. 4a: the printing device of FIG. 3 with the maintenance cartridge in a spit position in accordance with an example;

FIG. 4b: the printing device of FIG. 3 with the maintenance cartridge in a wiping position in accordance with an example;

FIG. 4c: the printing device of FIG. 3 with the maintenance cartridge in a scraping position in accordance with an example;

FIG. 5: a print head maintenance assembly with a side-facing guiding cam in accordance with an example;

FIG. 6a: a front view of a scraper assembly according to an example;

FIG. 6b: a front view of a maintenance cartridge according to an example;

FIG. 7: a perspective view of a maintenance cartridge according to another example

FIG. 8: a flow chart for an example of a method of cleaning a print head; and

FIG. 9: a flow chart for another example of a method of cleaning a print head.

### DETAILED DESCRIPTION

A print head can for example be cleaned by wiping the print head with a wiper to remove contaminants like dried ink or paper fibers, which may e.g. accumulate on the print head during printing. To this end, a printing device can comprise a maintenance cartridge with a wiping subsystem comprising the wiper. To improve the result of the cleaning, the wiper itself may be cleaned as well to remove material from a surface of the wiper. This may be achieved with a scraper assembly comprising a scraper, with which the wiper can be brought into contact by moving the maintenance cartridge relative to the scraper, thereby scraping the material off the surface of the wiper.

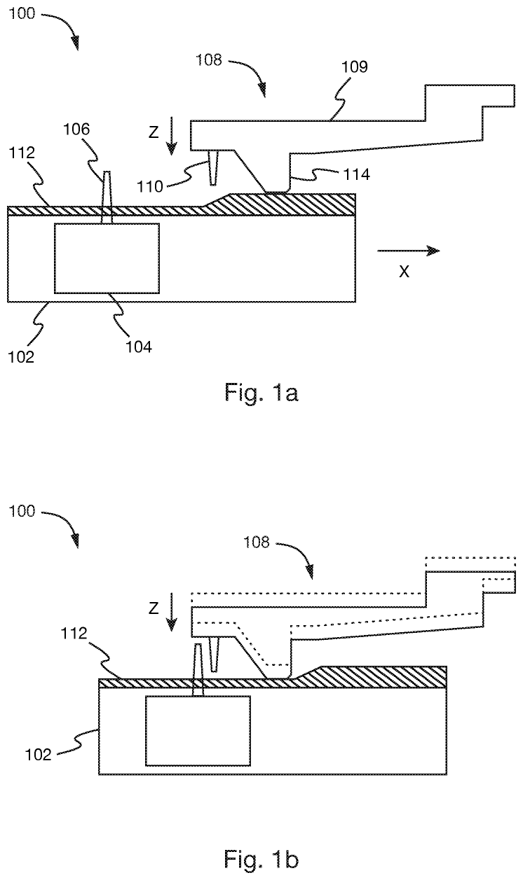

FIG. 1a depicts a side view of an example of a print head maintenance assembly 100. The print head maintenance assembly 100 may for example be employed in a printing device to clean a print head of the printing device (not shown in FIG. 1). The print head maintenance assembly 100 in this example comprises a maintenance cartridge 102 with a wiping subsystem 104. The wiping subsystem 104 comprises a wiper 106, which can comprise or consist of a flexible material like rubber. In one example, the wiper 106 can have a rectangular or approximately rectangular cross-section, with or without tapered side surfaces in the drawing plane of FIG. 1a and a rectangular or approximately rectangular shape extending along the direction perpendicular to the drawing plane of FIG. 1a. The wiper 106 may extend along a width direction of the maintenance cartridge 102 which, in FIG. 1a, is perpendicular to the drawing plane. The wiper may be used to clean a print head, e.g. by wiping over a nozzle plate of the print head to remove contaminants. Several wipers can be arranged side-by-side across the width of the maintenance cartridge 102.

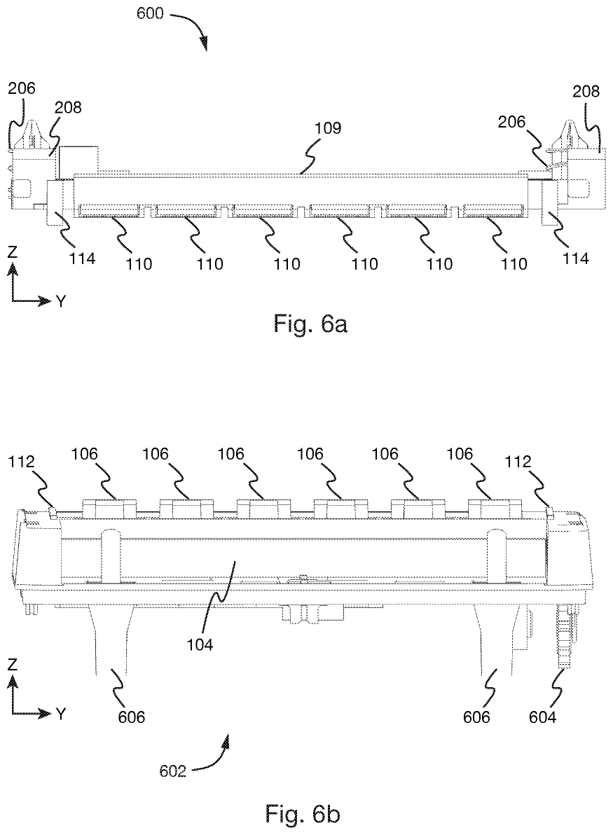

The contaminants can accumulate on a surface of the wiper 106 and can be removed in order to promote an efficient cleaning of the print head. For this, the print head maintenance assembly 100 comprises a scraper assembly 108 including a frame/body 109 and a scraper 110. The scraper assembly 108 may be attached to a support structure like a frame or chassis of a printing device. To remove contaminants from the surface of the wiper 106, the wiper 106 may for example be brought in contact with the scraper 110 in order to scrape contaminants off the wiper 106. The scraper 110 can be a rigid structure and can e.g. comprise or consist of plastic or metal or a combination thereof. The scraper 110 may be integrally formed with the frame/body 109 of the scraper assembly 108 or may be attached to the frame/body 109 of the scraper assembly 108. In one example, the scraper 110, in an operating position, may extend from the frame/body 109 of the scraper assembly 108 towards the wiper 106. The scraper no may have a sharp edge, which can be brought into contact with the wiper 106. For example, the scraper may have a U-shape in a plane perpendicular to the drawing plane of FIG. 1a with the two legs of the “U” being attached to or formed on the frame/body 109 of the scraper assembly 108 as detailed below with reference to FIG. 6a. A surface of the scraper 110 may be roughened, corrugated or otherwise structured to assist the scraping of contaminants from the wiper 106. Several scrapers can be arranged side-by-side across the width of the scraper assembly 108.

The print head maintenance assembly 100 further comprises a positioner to adjust a relative position between the scraper 110 and the wiper 106 in a first direction depending on the relative position between the maintenance cartridge 102 and the scraper assembly 108 in a second direction. In FIG. 1a, the first direction is indicated by the arrow labeled with “Z” and is denoted as the Z-direction in the following. The second direction is indicated by the arrow labeled with “X” in FIG. 1a and is denoted as the X-direction in the following. The X-direction and the Z-direction may be orthogonal with respect to each other. In one example, the print head maintenance assembly 100 may be used in a printing device. In this example, the Z-direction may be a vertical direction, whereas the X-direction may be a horizontal direction, e.g. a horizontal direction perpendicular to a third direction or scanning direction along which a print head of the printing device moves to traverse a scanning path of the print head, as explained further below. This third direction is denoted as the Y-direction in the following and may e.g. correspond to the direction of view of FIG. 1a.

In the context of this application, a relative position between two Objects is defined as the distance between two fixed points on the two objects, e.g. the centers of mass of the two objects or any predefined two points on respective surfaces of each of the two objects. Correspondingly, if the maintenance cartridge 102 and scraper assembly 108 are moved relative to each other in the X-direction, e.g. if the maintenance cartridge 102 is moved to the right along the arrow “X” in FIG. 1a whereas the scraper assembly 108 remains fixed, the positioner can move the wiper 106 or the scraper no along the Z-direction in order to change the relative position between the wiper 106 and the scraper no in the Z-direction.

In one example, the positioner comprises a guiding cam 112 to adjust the relative position between the scraper no and the wiper 106 in the Z-direction depending on the relative position between the maintenance cartridge 102 and the scraper assembly 108 in the X-direction. To this end, the guiding cam 112 may for example extend on the frame/body of the maintenance cartridge 102 or on the frame/body 109 of the scraper assembly 108 along the X-direction. The guiding cam 112 may e.g. be a protrusion or a groove extending along the X-direction. The guiding cam 112 may have a height profile along the X-direction with a height in the Z-direction that varies as a function of the position in the X-direction. The height profile may for example be a step or slope connecting a lower portion to a higher portion as in the example of FIG. 1a.

In the example depicted in FIG. 1a, the guiding cam 112 is arranged on a face of the maintenance cartridge 102 facing the scraper assembly 108. In this way, the guiding cam 112 can be used to adjust the relative position between the scraper 110 and the wiper 106 in the Z-direction e.g. by pressing against an opposing portion of the scraper assembly 108, e.g. a cam follower 114 of the scraper assembly 108 opposing the face of the maintenance cartridge 102, such that a relative position between the scraper assembly 108 and the maintenance cartridge 102 in the Z-direction changes depending on the relative position between the maintenance cartridge 102 and the scraper assembly 108 in the X-direction. The guiding cam 112 may be attached to the body/frame of the maintenance cartridge 102 or may be an integral part of the maintenance cartridge 102, e.g. part of a sidewall of the maintenance cartridge 102.

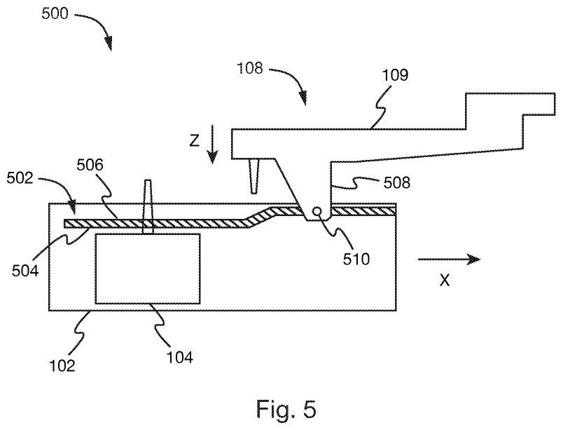

Alternatively, a guiding cam can be arranged on a side face of the maintenance cartridge 102, e.g. a side face perpendicular to the Y-direction. One example for this is detailed below with reference to FIG. 5. In another example, a guiding cam may be arranged on a face of the maintenance cartridge 102 facing away from the scraper assembly 108, e.g. a bottom face perpendicular to the Z-direction, or on a face of the wiping subsystem 104 facing away from the scraper assembly 108, e.g. to press against an opposing surface of a support structure or frame to move the maintenance cartridge 102 towards and away from the scraper assembly 108. Alternatively, a guiding cam may be arranged on a face of the frame/body 109 of the scraper assembly 108, e.g. a face of the scraper assembly 108 facing the maintenance cartridge 102. In this example, the maintenance cartridge may include a cam follower to engage with the guiding cam to move the maintenance cartridge 102 towards and away from the scraper assembly 108 or to move the scraper assembly 108 towards and away from the maintenance cartridge 102.

Alternatively, or additionally, the positioner may comprise an actuator, e.g. an electric motor or other controlled actuator, and position sensors in order to adjust the relative position between the scraper no and the wiper 106 in the Z-direction depending on the relative position between the maintenance cartridge 102 and the scraper assembly 108 in the X-direction. In one example, an electric stepper motor, servo motor, or a brushless DC motor may move the scraper 110 or the scraper assembly 108 along the Z-direction based on a measurement of the relative position between the maintenance cartridge 102 and the scraper assembly 108 by an optical position sensor, e.g. a photoelectric relay.

FIG. 1b illustrates an adjustment of the relative position between the scraper 110 and the wiper 106 for the print head maintenance assembly 100. As the maintenance cartridge 102 and the scraper assembly 108 are moved with respect to each other along the X-direction, e.g. by moving the maintenance cartridge 102 with an actuator, the relative position between the maintenance cartridge 102 and the scraper assembly 108 and thereby the relative position between the wiper 106 and the scraper no may be determined by the height profile of the guiding cam 112. For example, if the scraper assembly 108 is mounted movably and the guiding cam 112 presses against the cam follower 114 of the scraper assembly 108, the scraper assembly 108 may follow the height profile of the guiding cam 7112 such that the position of the scraper assembly 108 along the Z-direction can change if the maintenance cartridge 102 and the scraper assembly 108 are moved with respect to each other along the X-direction. The scraper assembly 108 may for example be attached to a support structure such that the scraper assembly 108 can move linearly along the Z-direction or pivot around a fixed axis in the direction of view of FIG. 1b. The dashed line in FIG. 1b illustrates the position of the scraper assembly 108 in the configuration shown in FIG. 1a. This position is higher along the Z-direction than the position of the scraper assembly 108 in the configuration of FIG. 1b, in which the maintenance cartridge is located farther to the right in the X-direction than in the configuration of FIG. 1a. In another example, the scraper assembly 108 may be fixed and the position of the maintenance cartridge 102 along the Z-direction may change following the height profile of the guiding cam 112, e.g. by pressing the maintenance cartridge 102 against the cam follower 114 of the scraper assembly 108.

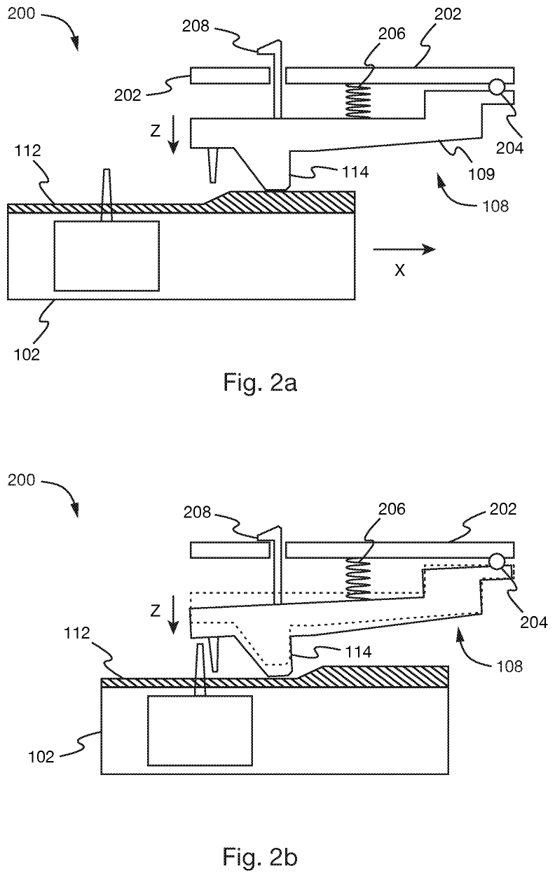

FIG. 2a illustrates another example of a print head maintenance assembly 200 in accordance with an example. Similar to the print head maintenance assembly too, the print head maintenance assembly 200 comprises a maintenance cartridge 102 with a wiping subsystem 104, a scraper assembly 108 with a scraper no and a guiding cam 112 on a face of the maintenance cartridge 102 facing the scraper assembly 108. The scraper assembly 108 is movably attached to a support structure 202 via a mount to enable movement of the scraper assembly 108 along the Z-direction. The support structure 202 may for example be a chassis or frame of a printing device.

In the example shown in FIG. 2a, the mount comprises a hinge 204, which connects the scraper assembly 108 to the support structure 202 in such a way that the scraper assembly 108 can pivot around an axis of the hinge 204. Thereby, if the scraper assembly 108 and the maintenance cartridge 102 are moved relative to one another, the scraper assembly 108 may for example follow the height profile of the guiding cam 112 by tilting such that the cam follower 114 of the scraper assembly 108 remains in contact with the guiding cam 112 as illustrated in FIG. 2b. In this way, the relative position between the scraper 110 and the wiper 106 in the Z-direction may be adjusted depending on the relative position between the maintenance cartridge 102 and the scraper assembly 108 in the X-direction. For comparison, the position of the scraper assembly 108 in the configuration of FIG. 2a is shown as a dashed line in FIG. 2b, In other examples, the hinge 204 may be formed by a contact point at which the support structure 202 and the scraper assembly 108 touch, e.g. a recess in the support structure 202, in which a corner or an edge of the body/frame 109 of the scraper assembly 108 is arranged such that the scraper assembly 108 can pivot around the contact point.

The mount may further comprise a spring 206 to exert a biasing force on the scraper assembly 108. One end of the spring 206 may for example be attached to the support structure 202, whereas the other end of the spring 206 may be attached to the frame/body 109 of the scraper assembly 108. The spring 206 can press the cam follower 114 of the scraper assembly 108 against the guiding cam 112, e.g. to ensure that the scraper assembly 108 follows the height profile of the guiding cam 112. In other examples, where the Z-direction is aligned with the direction of gravity, the gravitational force acting on the scraper assembly 108 due to its weight may be sufficient to ensure that the scraper assembly 108 follows the height profile of guiding cam 112. The spring 206 can further be employed to hold the scraper assembly 108 in place, e.g. if the maintenance cartridge 102 is removed. This may facilitate assembling and disassembling the print head maintenance assembly 200 as well as mounting the print head maintenance assembly 200 in a printing device. To this end, the scraper assembly 108 may further comprise an engaging element like a snap or hook 208 to be movably attached to a hole or a recess in the support structure 202. The hook 208 may be designed such that it limits the movement of the scraper assembly 108 in the Z-direction.

In another example, the scraper assembly 108 may be movably attached to the support structure 202 via a mount that enables linear movement of the scraper assembly along the Z-direction. Such a mount may for example comprise two or more springs for attaching the scraper assembly 108 to the support structure 202, e.g. a spring adjacent to each corner of the scraper assembly 108 as seen in top view, i.e. viewing along the Z-direction. Alternatively or additionally, the mount may e.g. comprise two or more engaging elements such as hooks to attach the scraper assembly 108 to the support structure 202, e.g. a hook adjacent to each corner of the scraper assembly 108 as seen in top view.

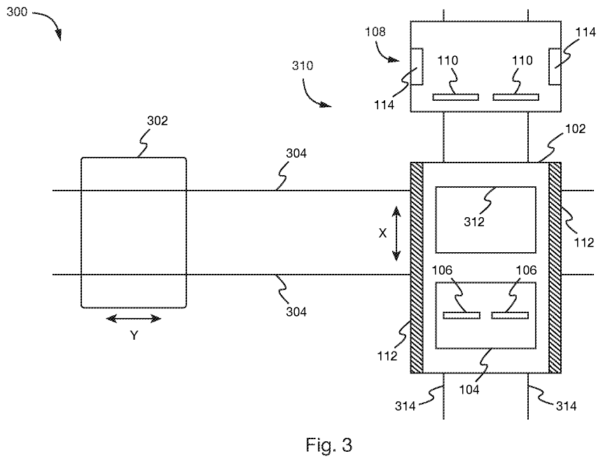

FIG. 3 shows a top view of a printing device 300 according to an example. The printing device 300 comprises a print head 302, e.g. an ink-jet print head having an ink reservoir for a printing fluid such as ink and a nozzle plate for distributing the printing fluid on a print medium. The print head 302 is movable along a print head path in a scanning direction, illustrated by the arrow labeled “Y” in FIG. 3 and denoted as the Y-direction in the following, which may e.g. be perpendicular to a direction of motion of the print medium, also referred to as media advance direction. The media advance direction may be aligned with the X-direction. The direction perpendicular to the plane of the print medium, corresponding to the direction of view in FIG. 3, is referred to as the vertical direction in the following, even though in some examples it may not be aligned with the direction of gravity. The Z-direction may be the vertical direction. The printing device 300 may comprise a print head actuator 304 for moving the print head along the print head path, for example an electric motor coupled to a carriage carrying the print head via a drive belt or a worm drive.

The printing device 300 further comprises a print head maintenance assembly 310 for cleaning the print head 302. The print head maintenance assembly 310 is similar to the print head maintenance assemblies 100 and 200 and may for example be located in the vicinity of an end point of the print head path, e.g. in a maintenance area next to a printing zone. The print head 302 and the print head maintenance assembly 310 can be located at different vertical positions such that the print head 302 may for example be moved above the print head maintenance assembly 310 in the direction of view in FIG. 3.

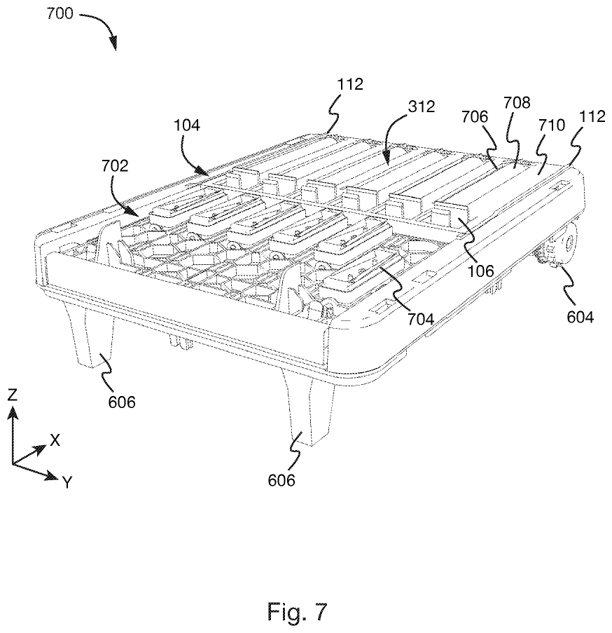

The print head maintenance assembly 310 comprises a maintenance cartridge 102 and a scraper assembly 108. Reference is made to the above description of FIGS. 1 and 2. In the example shown in FIG. 3, the wiping subsystem 104 comprises two wipers 106 arranged next to each other, e.g. for cleaning two different parts of the nozzle plate of the print head 302 that may be used for printing with two different colors. In other examples, the number of wipers 106 may be different and may be larger, e.g. six in one example. Correspondingly, the scraper assembly 108 may comprise multiple scrapers 110, e.g. one scraper for each of the wipers 106. In addition to the wiping subsystem 104, the maintenance cartridge 102 comprises a spittoon subsystem 312 with a reservoir for receiving material ejected from the print head 302. In one example, the spittoon subsystem 312 can comprise multiple reservoirs, e.g. two reservoirs for ink of two different colors. The spittoon subsystem 312 may also comprise a spit roller arranged in the reservoir as detailed below with reference to FIG. 7. The maintenance cartridge 102 may further comprise additional subsystems, for example a capping subsystem to cover the nozzle plate of the print head 302.

The print head maintenance assembly 310 further comprises an actuator 314 for moving the maintenance cartridge 102 along the X-direction, illustrated by the arrow labeled “X”, to traverse, the print head path. The actuator 314 can for example comprise an electric motor coupled to the maintenance cartridge 102 via a drive belt or a worm drive. The print head maintenance assembly 310 may comprise additional actuators, e.g. an actuator for moving an individual subsystem of the maintenance cartridge 102, or a transmission for coupling an individual subsystem of the maintenance cartridge 102 to the actuator 314, e.g. a gear transmission for moving a spit roller of the spittoon subsystem 312.

The print head maintenance assembly 310 also comprises a positioner to adjust a relative position between the scrapers 110 and the wipers 106 in the vertical Z-direction depending on the relative position between the maintenance cartridge 102 and the scraper assembly 108 in the X-direction. The positioner may for example comprise a pair of guiding cams 112 extending along the X-direction and arranged along opposing sides of a top face of the maintenance cartridge 102 to press against opposing portions/cam followers 114 of the scraper assembly 1a8.

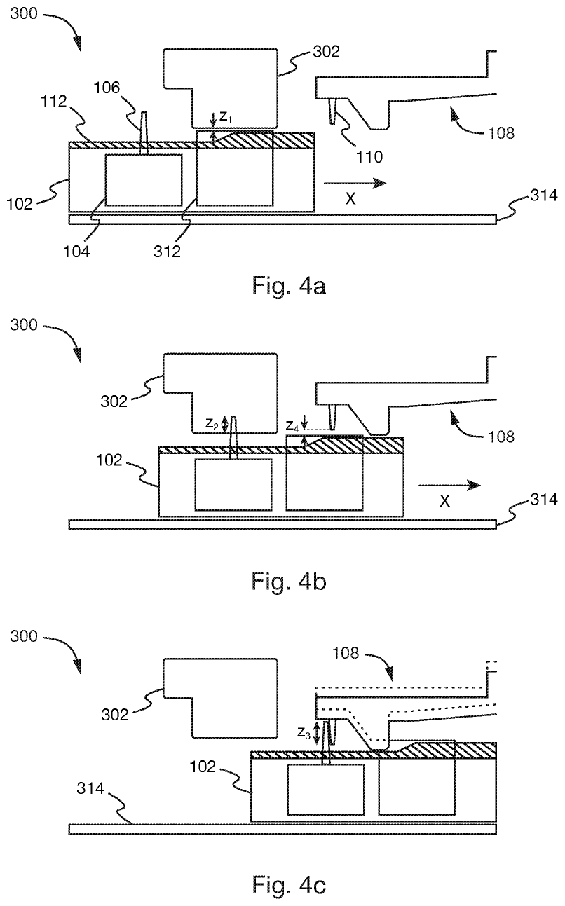

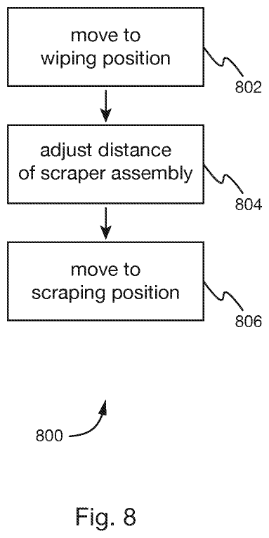

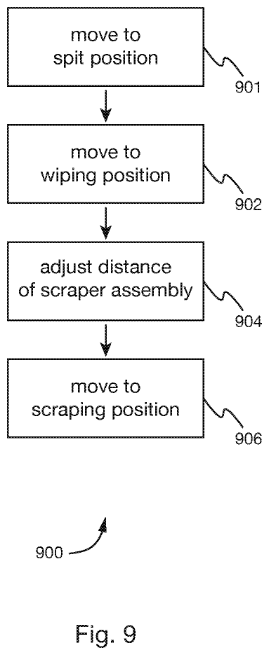

To clean the print head 302, the print head 302 may for example be moved to the maintenance area and subsequently be cleaned by moving the maintenance cartridge 102 along the X-direction, wherein the maintenance cartridge 102 may e.g. be located underneath the print head 302 in the vertical Z-direction. This is illustrated in FIGS. 4a-4c showing a side view of the printing device 300 along the Y-direction and is described in more detail below with reference to FIGS. 8 and 9. The actuator 314 may for example move the maintenance cartridge 102 between a spit position, shown in FIG. 4a, a wiping position, shown in FIG. 4b, and a scraping position, shown in FIG. 4c.

When the maintenance, cartridge 102 is in the spit position as depicted in FIG. 4a, the reservoir of spittoon subsystem 312 is located adjacent to a nozzle of the print head 302, e.g. below a bottom surface of the print head 302 on which a nozzle plate comprising the nozzle is arranged, in order to receive material like ink ejected from the print head 302. In this position, the reservoir of the spittoon subsystem 312 is separated from the print head 302 by a spit distance z₁.

In the wiping position as shown in FIG. 4b, the wiper 106 is in contact with the print head 302, e.g. with the bottom surface of the print head 302 on which the nozzle plate is arranged. The part of the surface of the wiper 106 in contact with the print head 302 in the wiping position is denoted as the wiping contact area. The wiping contact area has a vertical length z₂, which is the difference between the vertical position of the surface of the print head 302 that the wiper 106 is in contact with and the top of the wiper 106. The wiper 106 can consist of or comprise a flexible material and thus may bend when coming into contact with the print head 302. Correspondingly, the top of the wiper 106 refers to the highest point of the wiper 106 in the vertical Z-direction if the wiper 106 is not in contact with the print head 302 or any other element, e.g. if the print head 302 is outside of the maintenance area.

With the maintenance cartridge 102 in the scraping position as depicted in FIG. 4c, the scraper 110 is in contact with the wiper 106, e.g. with a side face of the wiper 106 that is in contact with the print head 302 in the wiping position. The part of the surface of the wiper 106 in contact with the scraper 110 in the scraping position is denoted as the scraping contact area. The scraping contact area has a vertical length z₃, which is the difference between the vertical position of the bottom of the scraper 110 and the top of the wiper 106, wherein the top of the wiper 106 is defined as described above. Depending on the shapes of the wiper 106 and the scraper no, not all of the scraping contact area may simultaneously be in contact with the scraper 110.

The positioner can for example adjust the relative position between the scraper assembly 108 and the maintenance cartridge 102 in the vertical Z-direction such that the scraper assembly 108 is closer to the maintenance cartridge 102 in the scraping position compared to the wiping position or the spit position, i.e. the distance between two respective points on the scraper assembly 108 and the maintenance cartridge 102 used to define the relative position is smaller in the scraping position. In the example shown in FIGS. 4a-4c, the height profile of the guiding cam 112 is chosen such that the scraper assembly 108 is lowered in the scraping position shown in FIG. 4c as compared to the wiping position of FIG. 4b and thus closer to the maintenance cartridge 102. For comparison, the position of the scraper assembly 108 in the wiping position of FIG. 4b is illustrated as a dashed line in FIG. 4c. By adjusting the distance between the scraper 110 and the wiper 106, the scraping contact area may be enlarged by increasing its vertical length z₃. This may facilitate the cleaning of the wiper 106 through the scraper 110.

In particular, an efficient removal of contaminants from the wiper 106 may be ensured by adjusting the distance between the scraper 110 and the wiper 106 such that the vertical length z₂ of the wiping contact area is not larger than the vertical length z₃ of the scraping contact area. In this case, the scraping contact area can be the same or larger than the wiping contact area such that the scraper no can come into contact with the entire area that may come into contact with the print head 302.

In one example, the positioner adjusts the relative position between the scraper assembly 108 and the maintenance cartridge 102 in the vertical Z-direction such that the spit distance z₁ between the reservoir of the spittoon subsystem 312 and the print head 302 in the spit position is smaller than the sum of the difference between the vertical length z₃ of the scraping contact area and the vertical length z₂ of the wiping contact area and a minimum distance z₄ between the spittoon subsystem 312 and the scraper no, i.e. z₁<(z₃−z₂)+z₄. Here, the distance z₄ is the smallest distance between the spittoon subsystem 312 and the scraper 110 that occurs when the maintenance cartridge 102 is moved between the spit position, the wiping position and the scraping position. The minimum distance z₄ can e.g. be required to be larger than a certain tolerance distance in order to avoid the scraper 110 touching the reservoir of the spittoon subsystem 312 or a spit roller arranged in the reservoir when the maintenance cartridge is moved. The aforementioned condition may for example be met with a guiding cam 112 with a height profile as shown in FIG. 4a-4c, for which the scraper assembly 108 is higher in the vertical Z-direction and thus farther away from the maintenance cartridge 102 when the spittoon subsystem 312 is underneath the scraper 110, e.g. in the wiping position, than in the scraping position.

In this way, the spit distance z₁ may be reduced by appropriately adjusting the relative position between the scraper assembly 108 and the maintenance cartridge 102 in the vertical Z-direction. When ejecting material from a nozzle of the print head 302 into the reservoir of the spittoon subsystem 312, aerosol may be generated, e.g. tiny ink particles or droplets suspended in air. These aerosols may leak out through a gap between the reservoir and the print head 302 and may contaminate other parts of the printing device 300. A smaller spit distance z₁ may therefore reduce the amount of aerosol leaking out when ejecting material from the nozzle of the print head 302 into the reservoir. This may enable the cleaning of the print head 302 without the need for actively extracting aerosol during the cleaning procedure. At the same time, the vertical length z₃ of the scraping contact area can be increased to improve the efficiency of the scraping without affecting the spit distance z₁. Furthermore, the minimum distance z₄ between the spittoon subsystem 312 and the scraper 110 may be increased independently of the spit distance z₁, which may allow for an increased tolerance with respect to vibrations or external perturbations without the scraper 110 touching the reservoir of the spittoon subsystem 312 or a spit roller arranged in the reservoir.

FIG. 5 depicts a side view of a print head maintenance assembly 500 with a side-facing guiding cam in accordance with an example. Similar to the print head maintenance assembly too, the print head maintenance assembly 500 comprises a maintenance cartridge 102 and a scraper assembly 108. The guiding cam can be arranged on a side face of the maintenance cartridge 102, e.g. a side face perpendicular to the Y-direction, wherein the guiding cam may for example comprise a groove or recess 502 (in the following commonly referred to as recess) extending along the X-direction as shown in FIG. 5. The recess 502 may be defined by a bottom wall 504 and an opposite top wall 506 and may extend through the side face of the maintenance cartridge 102 to form a cut-out or may have a closed side wall to form a groove. The bottom wall 504 of the recess 502 may have a height profile along the X-direction with a height, i.e. position of the bottom wall 504, in the Z-direction that varies as a function of the position in the X-direction. In one example, the two opposing bottom 504 and top walls 506 of the recess 502 may be parallel or approximately parallel to each other, i.e. exhibit the same height profile or approximately the same height profile, e.g. such that a width of the recess 502 in the Z-direction is the same or approximately the same along the length of the recess 502.

The scraper assembly 108 of the print head maintenance assembly 500 comprises a cam follower 508, which may further comprise a protrusion or pin 510, e.g. extending from the cam follower 508 along the Y-direction, to engage with the recess 502 of the guiding cam. The width of the pin 510 in the Z-direction and the position of the cam follower 508 comprising the pin 510 may be such that the pin 510 is in sliding contact with both of the bottom 504 and top walls 506 of the recess 502 when the pin 510 is arranged in the recess 502. Contact of the pin 510 with the opposing bottom 504 and top walls 506 of the recess 502 can facilitate guiding of the scraper assembly 108 and can ensure that the scraper assembly 108 follows the height profile of guiding cam. The recess 502 may extend up to one edge of the maintenance cartridge 102 in the X-direction, for example to allow for inserting and removing the pin 510 into/from the recess 502.

FIG. 6a shows a scraper assembly 600 according to an example in a front view perpendicular to the X-direction. The scraper assembly 600 may be similar to the scraper assembly 108 shown in FIG. 2a, from which the scraper assembly 600 mainly differs in that the scraper assembly 600 comprises a plurality of scrapers 110, e.g. six scrapers no as shown in FIG. 6a. The scrapers no may be part of or attached to the frame/body 109. Each of the scrapers 110 has a U-shape in the drawing plane of FIG. 6a, wherein the two legs of the “U” are connected to the frame/body 109. A bottom portion between the two legs of each of the scrapers no may be straight, aligned and parallel to respective wiper edges to be cleaned and may have a roughened, corrugated or otherwise structured surface for the scraping of contaminants. The scraper assembly 600 further comprises a pair of cam followers 114 arranged on opposing sides of the frame/body 109 as well as a pair of springs 206 and a pair of hooks 208, e.g. to pivotally attach the scraper assembly 600 to a support structure.

FIG. 6b depicts a front view of a maintenance cartridge 602 in accordance with an example, wherein the maintenance cartridge 602 interacts with the scraper assembly 600 shown in FIG. 6a. The maintenance cartridge 602 may be similar to the maintenance cartridge 102 shown in FIG. 3. The wiping subsystem 104 comprises a plurality of wipers 106. For example, the number of scrapers 110 of the scraper assembly 600 and the number of wipers 106 may be the same so that there is one scraper 110 for each of the wipers 106. Each of the wipers 106 may for example have a rectangular or approximately rectangular shape in the drawing plane of FIG. 6b. As indicated above, upper edges of the wipers 106 and lower edges of the scrapers 110 may be parallel and aligned.

The maintenance cartridge 602 further comprises a pair of guiding cams 112, which may be part of or attached to the frame/body of the maintenance cartridge 602. The guiding cams 112 may be arranged on opposing portions of the frame/body of the maintenance cartridge 602, e.g. such that the guiding cams 112 can be engaged by the pair of cam followers 114 of the scraping assembly 600. The maintenance cartridge 602 also comprises a gear drive 604, which may be coupled to the actuator 314, e.g. to move the maintenance cartridge 602 along a toothed rack extending along the X-direction, with which a gear of the gear drive 604 can be engaged. The maintenance cartridge 602 may further comprise a pair of cam followers 606, e.g. to follow a pair of guiding grooves or guiding cams on a frame or chassis of a printing device.

FIG. 7 illustrates a maintenance cartridge 700 according to another example in a perspective view. The maintenance cartridge 700 is similar to the maintenance cartridge 602 shown in FIG. 6b, but additionally comprises a spittoon subsystem 312 and a capping subsystem 702. The capping subsystem 702 comprises a plurality of caps 704, e.g. one cap for each nozzle plate of the print head 302. For simplicity, only a single cap is provided with a reference sign in FIG. 7. The caps 704 may e.g. be used to cover the nozzle plates of the print head 302 when the maintenance cartridge 700 is placed in a capping position.

The spittoon subsystem 312 comprises a plurality of reservoirs 706, e.g. one reservoir for each nozzle plate or for each row of nozzles or for each group of nozzles of a particular color of the print head 302. Each of the reservoirs 706 may comprise a spit roller 708, which is arranged in the respective reservoir, e.g. to transfer material ejected from the nozzles of the print head 302 into the reservoirs 706. For simplicity, only a single reservoir and a single spit roller are provided with reference signs in FIG. 7. The spit rollers 708 may in particular extend along the vertical Z-direction beyond a top surface 710 of the spittoon subsystem 312, i.e. may be closer to the scrapers no of the scraping assembly 600 than the top surface 710 when the maintenance cartridge 700 is placed underneath the scraping assembly 600. Correspondingly, the minimum distance z₄ between the spittoon subsystem 312 and the scrapers no may be determined by the distance between the spit rollers 708 and the scrapers no and the spit distance z₁ between the reservoirs 706 and the print head 302 in the spit position may be determined by the distance between the spit rollers 708 and the print head 302. Nonetheless, the height profile of the guiding cams 112 may be chosen such that the scrapers 110 do not come into contact with the spit roller 708 when the scrapers no are adjacent to the spittoon subsystem 312. Furthermore, each of the spit rollers 708 may be coupled to the gear drive 604 of the maintenance cartridge 700, e.g. to rotate the spit rollers 708.

FIG. 8 depicts a flowchart for an example 800 of a method of cleaning a print head in accordance with an example. The method 800 may for example be executed with the printing device 300 to clean the print head 302 and will be described in the following with reference to FIGS. 3 and 4a-4c. This is, however, not intended to be limiting in any way. The method 800 may be performed with any appropriate print head maintenance assembly comprising a maintenance cartridge having a wiping subsystem with a wiper for wiping the print head and a scraper assembly having a scraper for cleaning the wiper, e.g. also the print head maintenance assemblies 100 and 200.

The method 800 comprises, in 802, placing the wiping subsystem 104 in the wiping position adjacent to the print head 302 such that the wiper 106 is in contact with the print head 302; in 804, adjusting the relative position between the scraper no and the wiper 106 in the first direction depending on the relative position between the maintenance cartridge 102 and the scraper assembly 108 in the second direction; and, in 806, placing the wiping subsystem 104 in the scraping position adjacent to the scraper assembly 108 such that the wiper 106 is in contact with the scraper 110.

The method 800 may for example be executed at the beginning or end of each printing job of the printing device 300 or in regular service intervals during a printing job. For this, the print head 302 may be placed in the maintenance area, e.g. by moving the print head 302 along the print head path to a maintenance position, at which the print head 302 may remain throughout the execution of the method 800.

In 802, the wiper 106 is brought in contact with the print head 302, e.g. a bottom surface of the print head 302 on which a nozzle plate of the print head 302 is arranged. For this, the maintenance cartridge 102 may for example be moved by the actuator 314 to the wiping position. Thereby, contaminants like paper fibers or dried ink, which may accumulate on the print head 302 during printing operation, may be removed from the print head 302 and may be transferred to a surface of the wiper 106. Placing the wiping subsystem 104 in the wiping position may further comprise moving the wiping subsystem 104, e.g. along the second direction, such that the wiper 106 wipes along a surface of the print head 302.

In 804, the relative position between the scraper 110 and the wiper 106 is adjusted in the first direction, e.g. the vertical direction, depending on the relative position between the maintenance cartridge 102 and the scraper assembly 108 in the second direction. For example, if the maintenance cartridge 102 moves in the second direction, the distance between the scraper no and the wiper 106 may be changed e.g. by moving the scraper assembly 108 in the first direction. In other examples, the maintenance cartridge 102, the wiping subsystem 104, the wiper 106 or the scraper 110 may be moved in the first direction to adjust the relative position between the scraper 110 and the wiper 106.

For the printing device 300, the adjustment of the relative position can be implemented by the choice of an appropriate height profile of the guiding cam 112, which can press against a cam follower 114 of the scraper assembly 108 in contact with the guiding cam 112 and thereby can determine the position of the scraper assembly 108 in the first direction as a function of the relative position between the maintenance cartridge 102 and the scraper assembly 108 in the second direction. If the maintenance cartridge 102 is moved in the second direction by the actuator 314, the scraper assembly 108 may follow a path defined by the height profile of the guiding cam 112 such that when the maintenance cartridge 102 is e.g. moved from the wiping position shown in FIG. 4b to the scraping position in FIG. 4c, the scraper assembly 108 may be lowered and thus may move closer to the maintenance cartridge 102.

In 806, the wiper 106 is brought in contact with the scraper 110 by placing the wiping subsystem 102 in the scraping position adjacent to the scraper assembly 108, e.g. by moving the maintenance cartridge 102 to the scraping position using the actuator 314. Placing the wiping subsystem 102 in the scraping position may further comprise moving the wiping subsystem 104, e.g. along the second direction, such that the scraper 110 scrapes along a surface of the wiper 106. In this way, contaminants on the surface of the wiper 106, which for example may have been transferred from the print head 302 onto the wiper 1o6, may be removed from the wiper 106.

The flow diagram shown in FIG. 8 does not imply a certain order of execution for the method 800. As far as technically feasible, the method 800 may be performed in any order and different parts may be performed simultaneously at least in part. For example, in 804, the relative position between the scraper 110 and the wiper 106 in the first direction may be adjusted continuously, in particular while moving the wiping subsystem, e.g. to place the wiping subsystem in the wiping position in 802 or to place the wiping subsystem 104 in the scraping position in 806. In one example, the wiping subsystem 104 may first be placed in the wiping position in 802 to remove contaminants from the print head 302, before placing the wiping subsystem 104 in the scraping position in 804 to clean the wiper 106. In another example, the order may be reversed and the wiping subsystem 104 may first be placed in the scraping position in 806 to clean the wiper 106, before placing the wiping subsystem 104 in the wiping position in 804 to remove contaminants from the print head 302. In yet another example, the wiping subsystem 104 may repeatedly be placed in the wiping position and in the scraping position in an alternating order.

If the maintenance cartridge used for executing the method 800 comprises a spittoon subsystem 312, the method 800 may further comprise moving the spittoon subsystem 312 adjacent to the scraper 110, e.g. when moving the maintenance cartridge 102 to the wiping position as shown in FIG. 4b. In this case, the relative position between the scraper assembly 108 and the maintenance cartridge 102 in the first direction can be adjusted such that the scraper assembly 108 is closer to the maintenance cartridge 102 when the wiping subsystem 104 is in the scraping position compared to when the spittoon subsystem 312 is located adjacent to the scraper 110, e.g. in the wiping position. For the printing device 300, for example, the height profile of the guiding cam 112 can be chosen such that when the maintenance cartridge 102 is e.g. moved to the scraping position as shown in FIG. 4c, the scraper assembly 108 may move closer to the maintenance cartridge 102 by following the guiding cam 112, whereas the scraper assembly may be raised if the maintenance cartridge 102 is moved such that the spittoon subsystem 312 is arranged underneath the scraper 110.

FIG. 9 depicts a flowchart for another example 900 of a method of cleaning a print head according to an example. The method 900 may for example be executed with the printing device 300 to clean the print head 302 and will be described in the following with reference to FIGS. 3 and 4a-4c. This is, however, not intended to be limiting in any way. The method 900 may be performed with any appropriate print head maintenance assembly comprising a spittoon subsystem in addition to a maintenance cartridge having a wiping subsystem with a wiper for wiping the print head and a scraper assembly having a scraper for cleaning the wiper. As in FIG. 8, the flow diagram of FIG. 9 does not imply a certain order of execution for the method 900. As far as technically feasible, the method 900 may be performed in any order and different parts may be performed simultaneously at least in part, e.g. as described above for the method 800.

Similar to the method 800, the method 900 comprises, in 902, placing the wiping subsystem 104 in the wiping position adjacent to the print head 302 such that the wiper 106 is in contact with the print head 302; in 904, adjusting a relative position between the scraper 110 and the wiper 106 in the first direction depending on the relative position between the maintenance cartridge 102 and the scraper assembly 108 in the second direction; and, in 906, placing the wiping subsystem 104 in the scraping position adjacent to the scraper assembly 108 such that the wiper 106 is in contact with the scraper no. Each of these parts of the method 900 may e.g. be implemented as described above.

Moreover, in 904, the relative position between the scraper 110 and the wiper 106 in the first direction may be adjusted such that the length z₂ of the wiping contact area, i.e. the area of the surface of the wiper 106 in contact with the print head 302 in the wiping position, along the first direction is not larger than the length z₃ of the scraping contact area, i.e. the area of the surface of the wiper 106 in contact with the scraper 110 in the scraping position, along the first direction. This can for example be achieved with the guiding cam 112 of the printing device 300, which exhibits a height profile such that the scraper assembly 108 may be closer to the maintenance cartridge 102 in the scraping position than in the wiping position to increase the length z₃ of the scraping contact area.

In addition, the method 900 comprises placing the spittoon subsystem 312 in the spit position adjacent to a nozzle of the print head 302 in 901, e.g. by moving the maintenance cartridge 102 to the spit position using the actuator 314. Placing the spittoon subsystem 312 in the spit position may further comprise ejecting or spitting material, such as ink, from the nozzle of the print head 302, e.g. into a reservoir of the spittoon subsystem 312 placed underneath the nozzle or onto a spit roller arranged in the reservoir.

The relative position between the scraper 110 and the wiper 106 in the Z-direction may be adjusted in 904 such that the spit distance z₁ between the reservoir of the spittoon subsystem 312 and the print head 302 in the spit position is smaller than the sum of the difference between the length z₃ of the scraping contact area and the length z₂ of the wiping contact area and the minimum distance z₄ between the spittoon subsystem 312 and the scraper 110, i.e. z₁<(z₃−z₂)+z₄. The aforementioned condition may for example be met by adjusting the relative position between the scraper 110 and the wiper 106 with the guiding cam 112 with a height profile as shown in FIG. 4a-4c, for which the scraper assembly 108 is adjusted to be higher in the Z-direction and thus farther away from the maintenance cartridge 102 when the spittoon subsystem 312 is adjacent to the scraper no, e.g. in the wiping position of FIG. 4b, than in the scraping position. In this way, a small spit distance z₁ can be achieved, which as described above may prevent aerosol created by ejecting material from the nozzle of the print head 302 into the reservoir of the spittoon subsystem 312 from leaking out to other parts of the printing device 300.

In one example, the method 800 or the method 900 may further comprise covering a nozzle of the print head 302, e.g. by using a maintenance cartridge like the maintenance cartridge 700 which can be moved to the capping position, in which the cap 704 of the capping subsystem 702 of the maintenance cartridge 700 covers the nozzle. This may e.g. be done at the end of methods 800 and 900, respectively, when the print head is clean.

This description is not intended to be exhaustive or limiting to any of the examples described above. The print head maintenance assembly, printing device and method disclosed herein can be implemented in various ways and with many modifications without altering the underlying basic properties.

1. A print head maintenance assembly, the print head maintenance assembly comprising:
a maintenance cartridge comprising a wiping subsystem with a wiper for wiping a print head;
a scraper assembly with a scraper for cleaning the wiper; and
a positioner to adjust a relative position between the scraper and the wiper in a first direction depending on a relative position between the maintenance cartridge and the scraper assembly in a second direction.

2. The print head maintenance assembly of claim 1, wherein the positioner comprises a guiding cam having a height profile with a varying height to adjust the relative position between the scraper and the wiper in the first direction depending on the relative position between the maintenance cartridge and the scraper assembly in the second direction.

3. The print head maintenance assembly of claim 2, wherein the guiding cam is arranged on a face of the maintenance cartridge to press against an opposing portion of the scraper assembly to adjust a relative position between the scraper assembly and the maintenance cartridge in the first direction depending on the relative position between the maintenance cartridge and the scraper assembly in the second direction.

4. The print head maintenance assembly of claim 3, wherein the scraper assembly is movably attached to a support structure via a mount to enable movement of the scraper assembly along the first direction.

5. The print head maintenance assembly of claim 4, wherein the mount comprises a hinge pivotally connecting the scraper assembly to the support structure.

6. The print head maintenance assembly of claim 4, wherein the mount comprises a spring to exert a biasing force on the scraper assembly.

7. The print head maintenance assembly of claim 2, wherein the guiding cam comprises a recess on a side face of the maintenance cartridge, the recess extending in the second direction along the side face of the maintenance cartridge and having a bottom wall with a height profile with a varying height, wherein the scraper comprises a cam follower to be engaged with the recess.

8. A printing device comprising:
a print head, wherein the print head is movable along a print head path in a scanning direction;
a print head maintenance assembly with a maintenance cartridge, wherein the maintenance cartridge comprises a wiping subsystem with a wiper for wiping the print head and a spittoon subsystem with a reservoir to receive material ejected from the print head; and
an actuator for moving the maintenance cartridge along a second direction to traverse the print head path;
wherein the print head maintenance assembly further comprises:
a scraper assembly with a scraper for cleaning the wiper; and
a positioner to adjust a relative position between the scraper and the wiper in a vertical direction depending on the relative position between the maintenance cartridge and the scraper assembly in the second direction.

9. The printing device of claim 8, wherein the actuator moves the maintenance cartridge between a scraping position, in which the scraper is in contact with the wiper, a wiping position, in which the wiper is in contact with the print head, and a spit position, in which the reservoir of the spittoon subsystem is located adjacent to a nozzle of the print head.

10. The printing device of claim 9, wherein the positioner adjusts the relative position between the scraper assembly and the maintenance cartridge in the vertical direction such that the scraper assembly is closer to the maintenance cartridge in the scraping position compared to the wiping position or the spit position.

11. The printing device of claim 10, wherein a vertical length of a wiping contact area is not larger than a vertical length of a scraping contact area, wherein the wiping contact area is the area of the surface of the wiper in contact with the print head in the wiping position and the scraping contact area is the area of the surface of the wiper in contact with the scraper in the scraping position.

12. The printing device of claim 11, wherein the positioner adjusts the relative position between the scraper assembly and the maintenance cartridge in the vertical direction such that a spit distance between the reservoir and the print head in the spit position is smaller than the sum of a difference between the vertical length of the scraping contact area and the vertical length of the wiping contact area and a minimum distance between the spittoon subsystem and the scraper.

13. A method of cleaning a print head using a print head maintenance assembly, wherein the print head maintenance assembly comprises:
a maintenance cartridge having a wiping subsystem comprising a wiper for wiping the print head; and
a scraper assembly having a scraper for cleaning the wiper;
the method comprising:
placing the wiping subsystem in a wiping position adjacent to the print head such that the wiper is in contact with the print head;
adjusting a relative position between the scraper and the wiper in a first direction depending on the relative position between the maintenance cartridge and the scraper assembly in a second direction; and
placing the wiping subsystem in a scraping position adjacent to the scraper assembly such that the wiper is in contact with the scraper.

14. The method of claim 13, wherein the maintenance cartridge further comprises a spittoon subsystem, the method further comprising moving the spittoon subsystem adjacent to the scraper, wherein the relative position between the scraper assembly and the maintenance cartridge in the first direction is adjusted such that the scraper assembly is closer to the maintenance cartridge when the wiping subsystem is in the scraping position compared to when the spittoon subsystem is located adjacent to the scraper.

15. The method of claim 14, further comprising placing the spittoon subsystem in a spit position adjacent to a nozzle of the print head, wherein
a length of a wiping contact area along the first direction is not larger than a length of a scraping contact area along the first direction, wherein the wiping contact area is the area of the surface of the wiper in contact with the print head in the wiping position and the scraping contact area is the area of the surface of the wiper in contact with the scraper in the scraping position; and
the relative position between the scraper assembly and the maintenance cartridge in the first direction is adjusted such that a spit distance between the print head and a reservoir of the spittoon subsystem in the spit position is smaller than the sum of a difference between the length of the scraping contact area and the length of the wiping contact area and a minimum distance between the spittoon subsystem and the scraper.
